(19) United States
(12) Patent Application Publication
(10) Pub. No.: US 2024/0111291 A1
(43) Pub. Date: Apr. 4, 2024

(54) BUILDING INFRASTRUCTURE AND ROBOT COORDINATION METHODS AND SYSTEMS

(71) Applicant: Ford Global Technologies, LLC, Dearborn, MI (US)

(72) Inventors: Geoffrey Horowitz, Birmingham, MI (US); Yifan Chen, Ann Arbor, MI (US); Sarah Garrow, Coral Gables, FL (US); Gregory Linkowski, Dearborn, MI (US); Meghna Menon, Ann Arbor, MI (US); Songan Zhang, Newark, CA (US)

(73) Assignee: Ford Global Technologies, LLC, Dearborn, MI (US)

(21) Appl. No.: 17/937,400

(22) Filed: Sep. 30, 2022

(51) Int. Cl. G05D 1/02; G01C 21/20

(52) U.S. Cl. CPC G05D 1/0214; G01C 21/206; G05D 1/0231; G05D 1/0276

(57) ABSTRACT

Building infrastructure and robot coordination methods and systems are disclosed herein. An example method can include preregistering an autonomous vehicle with a building controller of a building to inform the building controller of arrival of the autonomous vehicle and a delivery request for a package, the delivery request specifying a recipient of the package, the recipient having a location in the building. The method can include determining completion of a validation routine with the autonomous vehicle, assigning a task management plan to the autonomous vehicle, the task management plan determining how the autonomous vehicle navigates through the building to deliver the package to the location, and tracking the autonomous vehicle through the building.

### BACKGROUND

When an autonomous vehicle, such as an autonomous delivery robot (AMR), enters a building with a package to deliver, the AMR may face multiple challenges that are distinct from those faced during outdoor navigation, such as authorization/permitting, localization, navigation through dense pedestrian traffic, traveling vertically through different floors, and so forth. More so, dynamic obstacles, such as humans, may present themselves randomly in hallways or other building areas.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a perspective view of an example system in accordance with one or more embodiments of the present disclosure.

FIG. 2 is a flowchart of an example AMR check-in and validation process in accordance with one or more embodiments of the present disclosure.

FIG. 3 is a schematic diagram of both AMR and building controllers in accordance with one or more embodiments of the present disclosure.

FIG. 4 is an example flow diagram of various methods in accordance with one or more embodiments of the present disclosure.

FIG. 5 is a flowchart of an example method in accordance with one or more embodiments of the present disclosure.

FIG. 6 is a flowchart of an example method for task management in accordance with one or more embodiments of the present disclosure.

FIG. 7 is a flowchart of another example method for cooperative package delivery between a building controller and an autonomous delivery device in accordance with one or more embodiments of the present disclosure.

### DETAILED DESCRIPTION

Overview

Disclosed herein are systems and methods for a service model that allows a building controller (e.g., smart infrastructure) to take full or partial control of an autonomous vehicle such as an autonomous mobile robot (AMR) during its entire journey inside the building (which may render the AMR as an RC vehicle). While an AMR is discussed at length herein, the present disclosure is not so limited and the disclosure can be applied to any fully or partially autonomous vehicle.

These processes may involve pre-registration of the robot with the building, a series of validation routines to facilitate compliance with building protocols and communication requirements, and the communication of necessary information between the robot and building controller to accomplish the delivery. The building controller may also obtain sensing and tracking information about the AMR's location and dynamic obstacles in the navigation space and may modify and communicate available data that is tailored to the AMR's specifications and objectives to the AMR. The building controller may have full or partial control of AMR as determined by the AMR's capabilities and the building's security requirements.

The building controller may be responsible for managing the registration of the AMR, task management, and the AMR's departure. When the AMR arrives at the building's entrance, the AMR may join a public network and undergo registration (e.g., validating the authenticity of AMR, setting up communication protocol, undergoing diagnostic/protocol checks (e.g., mazes, obstacles with dummies), confirming AMR's task, receiving AMR's metadata and specifications). After registration, the AMR may be transferred to a private network for task management, and the building controller may track the AMR using infrastructure sensing. The building controller may determine the location for package delivery (e.g., standard delivery location, recipient location, or recipient delivery instructions), manages the AMR's movement to the goal location, confirms the AMR's arrival at the goal location, request offloading of the delivery package, receives AMR confirmation of delivery, sets the AMR's new goal location as the building exit, and then manages the AMR's movement to the exit.

During movement to the goal location, the building controller may find the optimal path for the AMR, which may consider the shortest path, the AMR's specifications, and optimization based on pedestrian density, and discretize the path into several waypoints. At each waypoint, the subsection of the building map comprising the waypoint is sent to the AMR, so the AMR may never have the map for the full building. Maps may be 2D or 3D. The building controller may provide continuous instruction to navigate the AMR to each waypoint or may provide the waypoint and let the AMR navigate itself there. The building controller may be in communication with actuators (or other infrastructure elements) in the building (e.g., doors, elevators) and may confirm AMR arrival at each waypoint via infrastructure sensors. After the AMR has left the building, its pass key expires and it is disconnected from the network, so the building stops tracking the AMR.

### Illustrative Embodiments

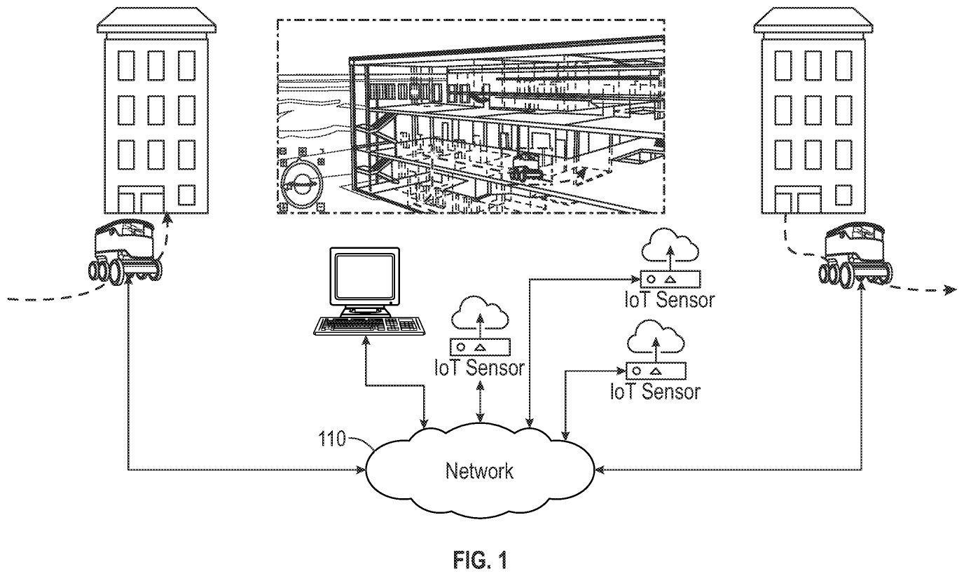

Turning now to the drawings, FIG. 1 depicts a portion of a system 100 that includes an AMR 102, a building controller 104 within a building 106 having an infrastructure sensor network 108 and infrastructure actuators 109, and a network 110. The network 110 can include any combination of public and/or private networks. For example, the network 110 can provide both public access and private access that can be used through a passkey, as will be disclosed in greater detail herein.

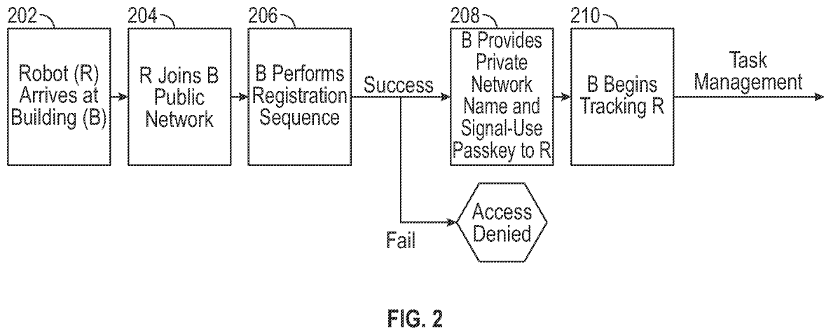

Broadly, when the AMR 102 arrives at the building 106 and negotiates for in-building service, it is the responsibility of the building controller 104 to manage registration, task management, and departure of the AMR 102. A high-level flow of the basic process for AMR control is illustrated in FIG. 2. In step 202, the robot (AMR), arrives at the building. In step 204, the AMR joins a public network of the building. In step 206, the building controller and AMR cooperatively execute a registration/validation process. It will be understood that in some instances, the AMR is pre-registered with the building controller prior to arrival, as will be discussed in greater detail herein. The registration/validation process can include AMR capability testing as well.

In more detail, when the AMR arrives at the entrance of the building, the AMR can join a public network and register with building. The building controller then validates AMR authenticity and establishes a communication protocol. The building controller can perform AMR diagnostic/protocol checks. Next, the building controller can receive a delivery task from AMR, such as an identification of an individual/recipient in the building who is to receive a package. The building controller can also receive AMR metadata such as dimensions, weight, and operating parameters.

If the registration/validation process is successful, the method includes a step 208 of providing the AMR with a private passkey and private network SSID (Service Set Identifier). Stated otherwise, once the AMR has been successfully registered it is transferred to a private network for task management. The building controller can provide the AMR with instructions for delivering the package to a recipient. This can include providing the AMR with a map that includes paths having waypoints.

In step 210, the building controller tracks the AMR and verifies package delivery. The building controller can use infrastructure sensor output, such as camera images, to assist the AMR in navigating from waypoint to waypoint. Camera images can be analyzed using pose detection, as well as other methods to identify and track the AMR. As the AMR encounters infrastructure features such as doors, elevators, and so forth, the building controller can actuate these features to allow the AMR to reach its destination. When the package has been delivered, the building controller can assist the AMR in exiting the building and revoking the passkey (could be timed to expire upon package delivery or after the AMR has exited the building). It will be understood that AMR tracking and navigation assistance can occur over the private network.

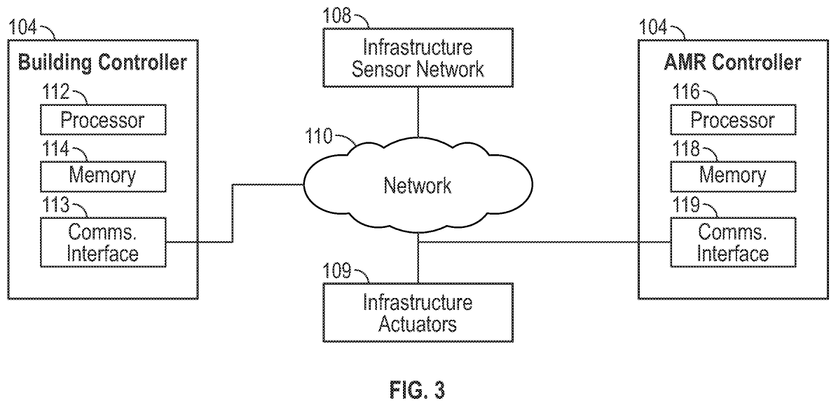

FIG. 3 is a schematic diagram of the building controller 104 and the example AMR 102. The building controller 104 can include a processor 112 and memory 114. The processor 114 executes instructions in the memory 114 to perform the methods disclosed herein. It will be understood that when referring to operations performed by the building controller, this includes the execution of instructions by the processor 112. Also, the building controller 104 can transmit and/or receive data over the network 110 using a communications interface 113, as will be discussed in greater detail herein, in order to interact with the AMR 102.

The AMR 102 includes an AMR controller 116 which includes a processor 118 and memory 120. The processor 118 executes instructions in the memory 120 to perform the methods disclosed herein. It will be understood that when referring to operations performed by the AMR controller, this includes the execution of instructions by the processor 118. Also, the AMR controller 102 can transmit and/or receive data over the network 110 using a communications interface 119 as will be discussed in greater detail herein, in order to interact with the building controller 104.

In a shared control scenario where control is divided between the AMR and the building controller, the AMR can be configured with instructions that providing onboard sensing (using sensors integrated into the AMR), path planning or navigation using a building map, contact avoidance (of both dynamic/moving and static objects using sensor data), localization relative to a building map, and motion control. The building controller can share a map and waypoints with the AMR. The building controller can be configured to utilize the output of the infrastructure sensing network, actuate building infrastructure elements (e.g., doors, locks, elevators, etc.), and map generation.

In a full control scenario, the AMR may have limited autonomous capabilities and function more as a radio-controlled device. In these instances, the AMR need only have onboard sensing and need not be provided a map. The building controller can transmit signals to control the movement of the AMR based on the current location of the AMR, as well as infrastructure sensing network output. The building controller can be configured to plan an optimal route, as well as determine traversable and non-traversable spaces throughout the building. The building controller can be tasked with localizing the AMR for implementing contact avoidance.

The building itself also includes various IoT (Internet of Things) sensors which are part of the infrastructure sensor network 108. IoT sensors can include optimized, wide-angle cameras positioned in various locations around the floors of the building. These cameras can connect to the network 110 and provide output, such as images to the building controller 104.

The building controller may associate a wireless signal used for communication with the AMR being tracked and directed. The AMR needs to know what communication protocol may be used how to communicate task status with the building controller. Both parties can establish trust and agree upon responsibility for various issues prior to the AMR entering the building.

A pre-registration informs the building controller of the AMR's arrival and desired task(s). Pre-registration instructs the AMR on how to check-in, or register, with the building upon arrival. It also establishes the ground rules: feature and protocol specifications and responsibility for potential issues, such as establishing requirements and expectations for both parties before arrival. It details minimum requirements (sensing, e-stop, etc.) for the AMR as well as parcel chain or possession and who is responsible for various issues that may arise.

The on-site check-in completes the process by ensuring the building correctly associates the physical robot with the ID used during wireless communication. During pre-registration, the AMR is given the specific means or protocols to indicate task completion, which the building controller can use to provide waypoints and other information.

As noted above, the AMR can be pre-registered with a building controller prior to arrival of the AMR. The pre-registration process can include the transmission of pre-registration information, which can include a delivery request for a package. The delivery request may specify a recipient of the package, and as noted above, the recipient has a location in the building. The pre-registration information can be transmitted by the AMR, by a delivery vehicle that transports the AMR, and/or by a dispatch or logistics backend.

In more detail, the pre-registration request can include a unique identifier for the AMR, which is similar to a vehicle identification number. The pre-registration request can also include map specifications that provide the AMR with advanced knowledge of how to navigate to the check-in location, such as the building entrance. The map can include a complete or partial map of the building in some instances. The map can include a two or three-dimensional map, depending on the capabilities of the AMR. The pre-registration request can also include information about the capabilities of the AMR, such as whether the AMR is semi or completely autonomous, what types of sensors the AMR possesses, what types of communication protocols the AMR can use, and what are the maneuvering capabilities of the AMR— just to name a few.

A task can have various types/components such as a map. The map can be updated by the building controller as needed (in some instances on a waypoint-to-waypoint basis). A waypoint task can be used to guide the AMR from one waypoint to another. The task can also specify autonomous operating parameters such as velocity and angle that can be used to direct the AMR in a more specific manner than only providing waypoint coordinates. The task components can specify drop-off details and explain how and where the package should be delivered. A task completion component can determine how the AMR informs the building controller that it has completed its task(s) and is ready to depart the building. There can also be an error identification and/or mitigation process where the AMR can transmit error codes such as lost, internal error, impassible path, weak signal, and so forth.

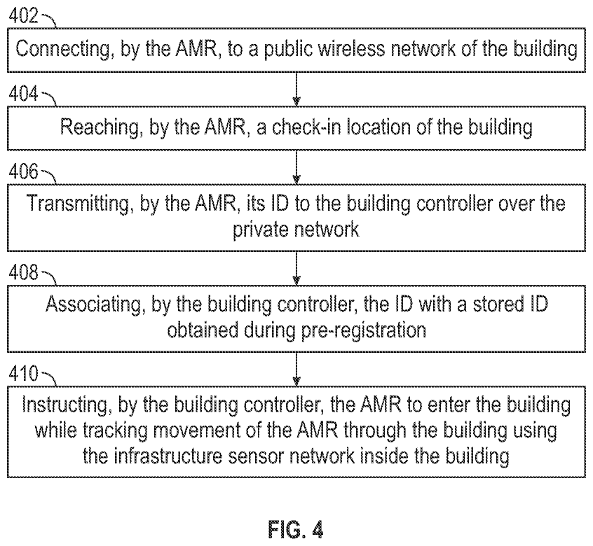

FIG. 4 illustrates a flowchart of an example method for check-in. The method can include a step 402 of connecting, by the AMR, to a public wireless network of the building. The method can also include a step 404 of reaching, by the AMR, a check-in location of the building. In step 406, the method includes transmitting, by the AMR, its ID to the building controller over the private network. In step 408, the method includes associating, by the building controller, the ID with a stored ID obtained during pre-registration. In step 410, the method includes instructing, by the building controller, the AMR to enter the building while tracking the movement of the AMR through the building using the infrastructure sensor network inside the building.

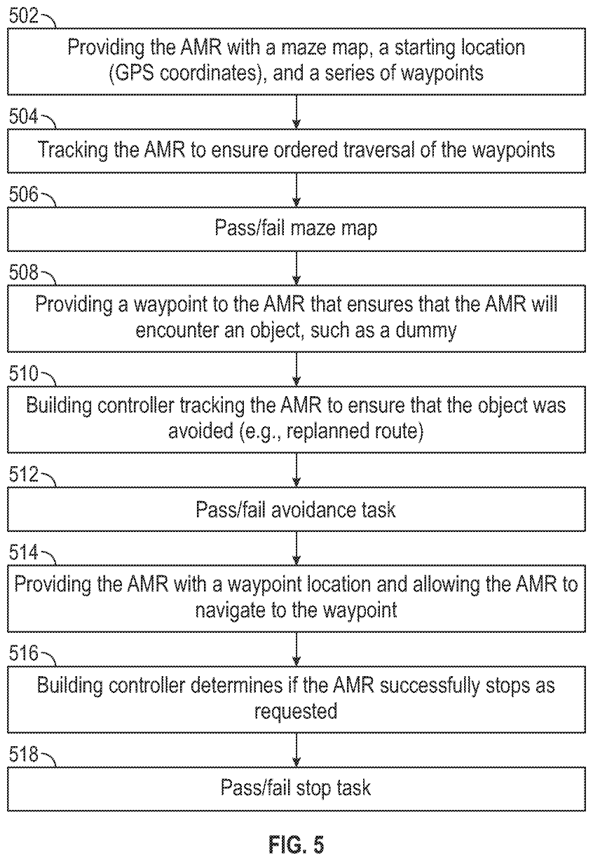

FIG. 5 illustrates a diagrammatic example of diagnostic and control processes that can be used to evaluate the capabilities of the AMR prior to allowing the AMR to enter the building. Generally, the process includes various setup, observation, and result steps which are tracked by the building controller.

This can include a process 502 of providing the AMR with a maze map, a starting location (GPS coordinates), and a series of waypoints. Another process 504 includes tracking the AMR to facilitate ordered traversal of the waypoints. Again, this can include the use of infrastructure sensors such as camera sensors, LiDAR, radar, infrared, ultrasonic, or other similar sensors. The AMR will either pass or fail these processes as noted in 506. If the AMR passes, another process 508 includes providing a waypoint to the AMR that ensures that the AMR will encounter an object, such as a dummy. The concept is to determine if the AMR can sense and self-navigate to avoid the object. A process 510 can include the building controller tracking the AMR to avoid the object (e.g., re-planned route). In process 512, the AMR either passes or fails. If the AMR passes, the next process includes a step 514 of providing the AMR with a waypoint location and allowing the AMR to navigate to the waypoint. During the navigation, the building controller can transmit a stop signal to the AMR. In process 516, the building controller determines if the AMR successfully stops as requested. In process 518, the building controller determines if the AMR passes or fails. If the AMR passes, it is allowed to enter the building.

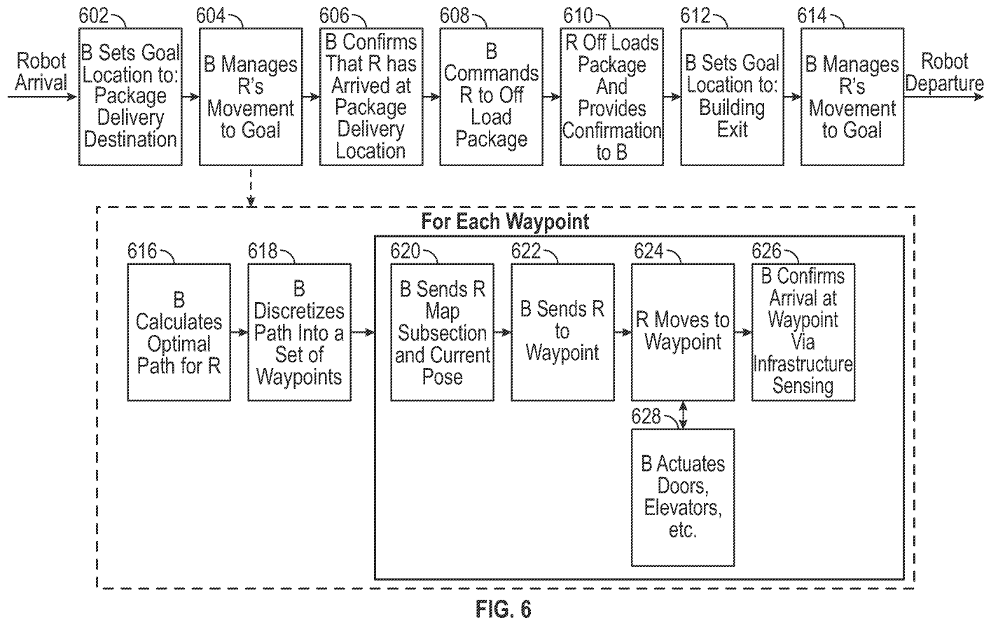

Referring now to FIG. 6, which is a flowchart of an example method for task management. The method can include a step 602 of determining a goal location (e.g., delivery location) for package delivery. For example, the information obtained from the AMR may indicate a name or floor for a recipient. The building controller can look up the individual in a table or database and determine a location of that individual in the building. For example, the building controller can identify that Jane Doe is the recipient and that she is located in a corner office on a second floor of the building. The delivery location could be a standard delivery location or rely internal data of person's desk location, or incorporate up to date information from the recipient of where the package should go building manages the robot's movement to the goal location.

In step 604, the building controller can manage (either entirely or in cooperation with native AMR navigation features) the movement of the AMR to one or more goals. This can include navigating the AMR through the building, which may include interaction with infrastructure actuators (e.g., doors, security system, and the like).

In more detail, the building controller can rely on the output of various infrastructure sensors, such as cameras, to detect AMR location, movement, and progress. This can include building design factors for optimal positioning of wide-angle vision sensors in scene, robust to occlusion and positioned for optimal coverage. The building can use edge compute to run pose estimation and tracking algorithms via key points/rotated bounding box detection for efficient pose estimation. In general, these features are described as infrastructure aided robotic that use a sparse number of optimally positioned wide angle cameras, which provide robust object detection and obstacle detection to aid AMRs in maneuvering through a scene/location.

The method can include a step 606 of the building controller confirming that the AMR has arrived at the correct location using infrastructure sensing. The method can also include a step 608 where the building controller requests the AMR to off load the package. Once the AMR offloads the package and provides confirmation to the building controller in step 610, the method can include a step 612 of the building controller resetting the goal location of the AMR to navigate to the building exit. In step 614, the method includes the building controller managing the AMR's movement to the goal location.

Steps 616-626 illustrate a detail description of an example process associated with step 604 above, related to AMR movement management. In this method, a step 616 may include the building controller determines/calculates an optimal path for the AMR. The optimal path may include a shortest path from a current location of the AMR to a goal, with consideration of AMR operating parameters and attributes such as footprint (size/dimensions), weight, speed, and so forth. The building controller can also receive an indication of the capabilities of the AMR, such as if the AMR is fully autonomous or not. Optimization of path can be based on pedestrian density throughout building.

In some instances, the building controller may discretize the path into a series of waypoints in step 618. For each waypoint, the method can include a step 620 of providing a subsection of a building map to the AMR that contains a current robot position and a waypoint location(s). Additional details on waypoint location and navigation will be disclosed infra. To be sure, this is a security and protocol feature, meaning that the AMR may not have a map of the entire building, just a partial map from waypoint to waypoint.

With respect to map building, the building controller can use the infrastructure sensing network (e.g., Scouter Mapping System, Infrastructure Mounted Depth Sensors, and so forth) to generate a partial or complete 3D map of the building. As part of the registration process, the AMR should specify if it needs to receive a 3D area map or 2D area map by sending a list of heights relative to the ground plane of its sensor stack. A list is provided to accommodate multiple 2D maps if the AMR has multiple sensors at different heights. An empty list can be provided to indicate a full 3D area map is needed. With the height information, the building controller can generate a series of 2D slices directly from the 3D map. These slices correspond to the 2D map the AMR would otherwise generate from its sensing stack.

With respect to map transfer, for each 2D slice, the building controller can generate an occupancy grid-map indicating occupied and otherwise non-traversable areas of the map. The map can be a list of lists. Map meta-data can include a position of an origin (first element) in the global frame <x,y,yaw>, as well as grid cell size in meters, and an initial pose of the AMR (again in <x,y,yaw>). The map can be in a grid cell format, where each object can be identified as a series of 0s and 1s, where the former indicates frees space and the later as occupied. The map can be updated in real-time based on sensor output, which can identify when objects such as humans are present and/or moving. The AMR can also receive updated occupancy data from the building controller as well.

In some instances, the building controller can create a partial map for the AMR. The partial map can be created by generating or updating the current 3D map, as well as generating a plurality of map slices. The map can be converted using AMR metadata and published to the AMR as a topic or task component.

The use of a partial map provides significant computation reduction as the building controller is already generating and updating a 3D world map, and generating slices of that map is a low-computation cost process. An AMR can be configured to obtain an area map without human intervention to pre-map the space for the specific AMR configuration and without related processes which may be unreliable and cause significant drift.

In step 622, the building controller sends the AMR to the waypoint (depending on the type of building control). In a full control scenario, the building controller may provide a continuous twist (velocity) command to the AMR. The building controller utilizes output of the infrastructure sensing elements for continuous feedback. In a semi-control scenario, the building controller may the waypoint location and the AMR uses native navigation stack to move to the goal.

Simultaneously, in step 624, the building controller communicates with actuators such as doors, elevators, as the AMR arrives at each infrastructure object. The building controller can determine when the AMR is at an infrastructure object using images from cameras around the infrastructure object or from location data reported to the building controller by the AMR.

In some instances, the building controller is configured to confirm the arrival of the AMR at the waypoint using infrastructure sensing. For example, method can include a step 626 of the building controller confirming the arrival of the AMR when the AMR approaches a camera at the waypoint of the building. The method can also include as step 628 where the building controller actuates various infrastructure actuators to allow the AMR to gain access to areas of the building behind doors. This step also allows the building controller to guide the AMR to an elevator and allow the AMR to travel from floor to floor.

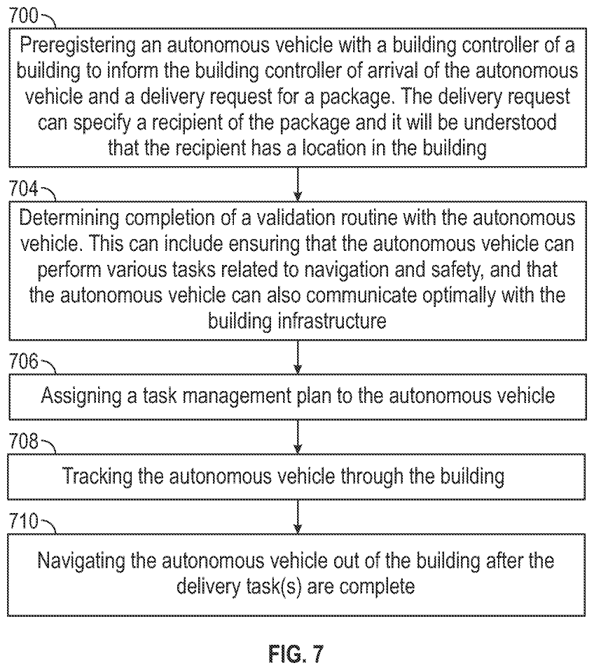

FIG. 7 is a flowchart of an example method of the present disclosure. The method can include a step 702 of preregistering an autonomous vehicle with a building controller of a building to inform the building controller of arrival of the autonomous vehicle and a delivery request for a package. The delivery request can specify a recipient of the package and it will be understood that the recipient has a location in the building.

Part of the pre-registration process can involve providing the autonomous vehicle with coordinates to a check-in location of the building, and wireless network credentials for a public network. The validation routine is performed over the public network. The autonomous vehicle can be provided a passkey to access a private network once the autonomous vehicle has been validated. The delivery request and the task management plan are provided over the private network. The passkey expires after confirming that the package has been delivered to the location. In another example, the passkey expires as the building controller detects that the AMR has exited the building. For example, the building controller can receive output from a door sensor or camera that indicates that the AMR has passed through an exit door (this could be the entry point of the building where the AMR checked in, or another exit established by the building controller).

The method can also include a step 704 of determining completion of a validation routine with the autonomous vehicle. This can include ensuring that the autonomous vehicle can perform various tasks related to navigation and that the autonomous vehicle can also communicate optimally with the building infrastructure.

In some instances, the method includes a step 706 of assigning a task management plan to the autonomous vehicle. In general, the task management plan defines how the autonomous vehicle navigates through the building to deliver the package to the location, or other various tasks that the autonomous vehicle performs during its time inside the building. In some instances, the task management plan comprises a map of all or a portion of the building, acceleration and angle values, the location, and an error protocol. The map can be either two or three dimensional depending on the capabilities of the autonomous vehicle.

The method can include calculating an optimal path to the location for delivery, which can include waypoints, wherein for each waypoint the method can include providing the autonomous vehicle with directions to a waypoint and confirming that the autonomous vehicle has reached the waypoint before transmitting additional directions to guide the autonomous vehicle to a subsequent waypoint.

The method can also include a step 708 of tracking the autonomous vehicle through the building, and a step 710 of navigating the autonomous vehicle out of the building after the delivery task(s) are complete. During navigation, the building controller can actuate building infrastructure elements as the autonomous vehicle is navigated through the building, such as opening doors or activating elevators.

Implementations of the systems, apparatuses, devices and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general-purpose computer, special purpose computer, or special purpose processing device to perform a certain function or group of functions. An implementation of the devices, systems and methods disclosed herein may communicate over a computer network. A “network” is defined as one or more data links that enable the transport of electronic data between computer systems and/or modules and/or other electronic devices.

While various embodiments have been described above, it should be understood that they have been presented by way of example only, and not limitation. The descriptions are not intended to limit the scope of the disclosure to the particular forms set forth herein. To the contrary, the present descriptions are intended to cover such alternatives, modifications, and equivalents as may be included within the spirit and scope of the disclosure as defined by the appended claims and otherwise appreciated by one of ordinary skill in the art. Thus, the breadth and scope of a preferred embodiment should not be limited by any of the above-described exemplary embodiments.

What is claimed is:

1. A method comprising:
preregistering an autonomous vehicle with a building controller of a building to inform the building controller of arrival of the autonomous vehicle and a delivery request for a package, the delivery request specifying a recipient of the package, the recipient having a location in the building;
determining completion of a validation routine with the autonomous vehicle;
assigning a task management plan to the autonomous vehicle, the task management plan determining how the autonomous vehicle navigates through the building to deliver the package to the location; and
tracking the autonomous vehicle through the building.

2. The method according to claim 1, further comprising calculating an optimal path to the location, the optimal path comprising waypoints, wherein for each way point, the method comprises:
providing the autonomous vehicle with directions to a waypoint and confirming that the autonomous vehicle has reached the waypoint before transmitting additional directions to guide the autonomous vehicle to a subsequent waypoint.

3. The method according to claim 2, further comprising actuating building infrastructure elements as the autonomous vehicle is navigated through the building.

4. The method according to claim 1, further comprising confirming that the autonomous vehicle has arrived at the location and transmitting a command to the autonomous vehicle to offload the package.

5. The method according to claim 4, further comprising transmitting instructions to the autonomous vehicle to navigate out of the building.

6. The method according to claim 1, further comprising checking in the autonomous vehicle by validating an identifier provided during preregistration.

7. The method according to claim 1, wherein the task management plan further comprises a map of all or a portion of the building, acceleration and angle values, the location, and an error protocol.

8. The method according to claim 1, further comprising providing the autonomous vehicle with coordinates to a check-in location of the building, and wireless network credentials for a public network.

9. The method according to claim 8, wherein the validation routine is performed over the public network, the method further comprising providing a passkey to the autonomous vehicle to access a private network once the autonomous vehicle has been validated, the delivery request and the task management plan being provided over the private network.

10. The method according to claim 9, wherein the passkey expires after confirming that the autonomous vehicle has exited the building.

11. A system comprising:
an infrastructure sensor network within a building; and
a building controller comprising a processor and memory for storing instructions, the processor executing the instructions to:
preregister an autonomous vehicle to inform the building controller of arrival of the autonomous vehicle and a delivery request, the delivery request specifying a recipient of a package, the recipient having a location in a building;
determine that the autonomous vehicle has arrived at a check-in location;
determine completion of a validation routine with the autonomous vehicle;
assign a task management plan to the autonomous vehicle, the task management plan determining how the autonomous vehicle navigates through the building to deliver the package to the location;
determine that the autonomous vehicle has delivered the package; and
instruct the autonomous vehicle to leave the building.

12. The system according to claim 11, wherein the building controller is configured to perform a diagnostic check on the autonomous vehicle by:
providing the autonomous vehicle with a maze map of a test area;
track the autonomous vehicle as it navigates through the maze map using the infrastructure sensor network; and
determine when the autonomous vehicle passes or fails navigation through the maze map.

13. The system according to claim 12, wherein the maze map includes an object that is intentionally placed in a path of the autonomous vehicle in such a way that the autonomous vehicle must self-navigate around the object to avoid contact with the object.

14. The system according to claim 13, wherein the processor is configured to determine that the autonomous vehicle has successfully navigated around the object using output from the infrastructure sensor network.

15. The system according to claim 14, wherein the processor is configured to:
transmit a stop signal to the autonomous vehicle; and
determine that the autonomous vehicle stopped in response to the stop signal.

16. The system according to claim 11, wherein the processor is configured to calculate an optimal path to the location, the optimal path comprising waypoints.

17. The system according to claim 16, wherein the processor is configured to transmit directions to each of the waypoints in succession as the autonomous vehicle from waypoint to waypoint, wherein the processor confirms that the autonomous vehicle has reached a waypoint based on output received from the infrastructure sensor network, the infrastructure sensor network comprising a camera at each waypoint.

18. The system according to claim 17, wherein the processor is configured to execute pose estimation on images obtained from the camera.

19. The system according to claim 18, wherein the processor is configured to detect an object in the images and transmitting instructions to the autonomous vehicle to avoid the object.

20. The system according to claim 11, wherein the validation routine is performed over a public network, wherein the processor is configured to provide a passkey that the autonomous vehicle uses to access a private network after the autonomous vehicle has been validated, the delivery request and the task management plan being provided over the private network, the passkey expires after confirming that the package has been delivered to the location.
